(19) United States
(12) Patent Application Publication
(10) Pub. No.: US 2010/0217526 A1
(43) Pub. Date: Aug. 26, 2010

(54) METHOD FOR SIMPLE OPTICAL AUTONOMOUS REFUELING SYSTEM

(75) Inventors: R. Parker McElveen, Fort Worth, TX (US); Michael I. Jones, Azle, TX (US); Marcus D. Dawson, Fort Worth, TX (US)

Correspondence Address: Bracewell & Giuliani LLP, P.O. Box 61389, Houston, TX, 77208-1389, US

(73) Assignee: LOCKHEED MARTIN CORPORATION, BETHESDA, MD (US)

(21) Appl. No.: 12/393,144

(22) Filed: Feb. 26, 2009

(51) Int. Cl. G05D 1/02; B64D 39/00

(52) U.S. Cl. 701/300; 244/135 A

(57) ABSTRACT

The present inventions provides for a system and method to facilitate dynamic spatial positioning of a second vehicle in relation to a first vehicle autonomously. The system includes a first vehicle, a second vehicle, a light pattern located on the first vehicle, an imaging system, and a processor. The imaging system is located on the second vehicle and is operable to receive a signal from the light pattern while having a clear line of sight with the light pattern. Furthermore, the processor is in communication with the imaging system, such that the processor is operable to determine the spatial positioning between the first vehicle and the second vehicle. Additionally, the processor is further operable to communicate instructions to the second vehicle, such that the second vehicle can achieve the desired spatial positioning autonomously.

### BACKGROUND OF THE INVENTION

1. Technical Field of the Invention

The present invention relates generally to autonomous positioning of two objects, and specifically, providing optical and/or electronic positioning devices on a first aircraft so as to provide guidance to an unmanned second aircraft such that the first and second aircraft may be spatially positioned, relative to one another, for applications such as autonomous in-flight refueling, airborne payload transfer, ship-to-sub positioning, UAV carrier landings, and ship-to-helicopter positioning and recovery.

2. Background of the Invention

Current attempts at autonomous positioning of two vehicles are extremely costly, requiring the use of highly specialized infrared or visual cameras that attempt to correlate the image of a target vehicle to stored patterns in a database and use sophisticated image processing techniques to determine the chase vehicle's position relative to the target.

As an example, air to air refueling of UAVs requires particularly precise and sustained positioning of the UAV with respect to the tanker. The specified error margin for this positioning is 1 inch at a distance of 50 feet from the tanker. This has historically been attempted through the use of Global Positioning Systems (GPS) for rough positional accuracy and complex, pattern-matching visual systems for refinement of positional accuracy to the required precision. A new system is needed to more accurately position airborne vehicles. This is especially necessary in a GPS-denied environment.

Therefore, it would be beneficial to have a method and apparatus for the precise relative positioning of two vehicles without the need for highly complex equipment, GPS dependence, or intervention from human controllers such as a refueling aircraft boom operator or remote UAV command center.

### SUMMARY OF THE INVENTION

The present invention is directed to a method that satisfies at least one of these needs. A positioning system for positioning a first object with respect to a second object is presented herein. The system includes two primary components: a light pattern and an imaging system. The imaging system includes a camera and lens combination, which is selected based on resolution requirements, and a processing system for capturing and analyzing the images. The light pattern includes a distinct geometric pattern of lighting elements oriented so as to provide clear line-of-sight imaging during positioning maneuvers. Examples of the lighting elements are light emitting diodes (LEDs), glassbead reflectors or fiber optics, all of which can be chosen to provide minimal risk to the vehicle frame and minimal cost for Safety of Flight Certification.

Generally, the first and second objects according to the described embodiments are the tanker (illustrative of the first object) and the UAV (illustrative of the second object), however, the invention is generally applicable to positioning other objects utilizing the system and methods described herein without departing from the spirit and scope of the present invention.

In one embodiment of the present invention, the automatic positioning system includes a first object, a second object, a light pattern, an imaging system, and a processor in communication with the imaging system. The light pattern is preferably located on the first object; however, other embodiments of the invention could place the light pattern on the second object. The light pattern is made up of a distinct geometric pattern of lighting elements. The imaging system is operable to receive a light signal from the lighting elements while having a clear line of sight with the light elements. The processor is operable to determine the spatial positioning between the first object and the second object, as well as communicate instructions to the second object, such that the second object can achieve the desired spatial positioning autonomously.

In one embodiment, the first and second objects are both aircrafts, with one aircraft being a tanker aircraft, and the other aircraft being a receiver aircraft. In an embodiment where the tanker aircraft is a hose and drogue type, the light pattern is preferably positioned on the drogue, and the imaging system is positioned on a forward upper surface of the receiver aircraft. In an embodiment where the tanker aircraft is a boom type, the light pattern is preferably positioned on an aft portion of the tanker aircraft, and the imaging system is positioned on a forward, upper surface of the receiver aircraft.

In one embodiment of this invention, the imaging system is integrated on the forward, upper surface of the second object, viewing through an environmental window. The imaging system captures images of a distinct 2D light pattern placed on the aft body of the first object in proximity to the refueling window. However, in an embodiment in which the first object is a hose-and-drogue type tanker, the light pattern can be placed on the drogue. These images are processed with a simple centroiding algorithm and are used to determine the second object's six (6) degree of freedom (6 DOF) positional relationship to the light pattern in preparation for midair refueling. The resulting positional relationship is used to autonomously fly the second object to the required positional window for refueling.

In one embodiment, the lighting elements have been selected to transmit in the Near Infrared (NIR) portion of the spectrum, with a preferred range of 0.75 to 1.4 μm, and a more preferred range of 0.8-0.9 μm. Accordingly, the second object's lens is filtered to pass only the selected portion of the spectrum. The camera lens has been selected to provide the 6 DOF resolution required while maintaining the required field of view (FOV). Integration of the lighting elements on the tanker aircraft platforms provides minimal risk to the tanker frame and minimal cost for Safety of Flight Certification. In one embodiment, the light pattern can be activated by the tanker boom/drogue operator as part of the overall refueling process. In another embodiment, deflector lenses can be integrated over the lighting elements to limit the solid angle of radiation and, thus, detection by potential threats. The FOV of these deflector lenses is matched to the FOV of the second aircraft camera.

In one embodiment of the present invention, an automatic aircraft positioning system to facilitate dynamic in-flight spatial positioning of a first aircraft with a second aircraft is provided. In this embodiment, the positioning system includes a first aircraft, a second aircraft, a light emitting source located on the first aircraft, an imaging system, and a processor. In this embodiment, the imaging system is Located on the second aircraft and is operable to receive a signal from the light emitting source while having a clear line of sight with the light emitting source. Furthermore, the processor is in communication with the imaging system, such that the processor is operable to determine the spatial positioning between the first aircraft and the second aircraft. Additionally, the processor is further operable to communicate instructions to the second aircraft, such that the second aircraft can achieve the desired in-flight spatial positioning autonomously.

In other embodiments of the present invention, either of said aircrafts can be the tanker aircraft or the receiver aircraft. Additionally, the embodiments of the present invention also allow for use of a hose and drogue tanker aircraft or a boom type tanker aircraft. Likewise, the receiver aircraft can be equipped with a probe or a receptacle depending upon the type of tanker aircraft used. When a boom type tanker aircraft is used, the plurality of lighting elements are preferably located on an aft portion of the tanker aircraft, and the imaging system is positioned on a forward, upper surface of the receiver aircraft. This configuration allows for a continuous line of sight between the plurality of lighting elements and the imaging system. In embodiments in which a hose and drogue type tanker are used, the light emitting source is preferably positioned on the drogue, with the imaging system again positioned on a forward, upper surface of the receiver aircraft.

In an additional embodiment of the present invention, the plurality of lighting elements includes light emitting diodes (LEDs), fiber optics, or glassbeads that are operable to transmit light within a specified wavelength range. In another embodiment, the imaging system includes a high resolution camera lens operable to receive only light signals within the specified wavelength range of the lighting elements. In one embodiment, the specified wavelength range is 0.75 to 1.4 μm, and more preferably 0.8 to 0.9 μm. In another embodiment, the imaging system includes a band-pass filter which only passes light signals within the specified wavelength range of the lighting elements. Use of such band-pass filters simplifies the positioning computations even further.

In a further embodiment of the present invention, the plurality of lighting elements further includes lenses that are capable of limiting the solid angle of radiation from the plurality of lighting elements. These lenses advantageously prevent the light from the plurality of lighting elements from projecting into unwanted locations and possibly compromising the location of the first aircraft,

In an additional embodiment, the automatic aircraft positioning system to facilitate in-flight re-fueling of a receiver aircraft by a tanker aircraft includes a receiver aircraft, a tanker aircraft, a plurality of plurality of lighting elements located on the tanker aircraft, an imaging system located on the receiver aircraft and a processor. The plurality of lighting elements emits light within a specified wavelength range and are spaced relative to each other in selected geometric patterns. The imaging system includes a camera lens that is operable to filter out all wavelengths of light with the exception of the light within the specified wavelength range. Moreover, the imaging system is positioned on the second aircraft such that it maintains a clear line of sight with the plurality of lighting elements. The processor is in communication with the imaging system, and is preferably located on the second aircraft. The processor is operable to determine the spatial positioning between the plurality of lighting elements and the receiver aircraft by comparing an observed pattern to the selected geometric pattern as to whether the observed pattern and the selected geometric pattern align. Additionally, the processor is capable of communicating flight instructions to the receiver aircraft, such that the receiver aircraft can achieve the desired in-flight spatial positioning autonomously.

In an additional embodiment of the present invention, a method to facilitate dynamic in-flight spatial positioning of a first aircraft with a second aircraft includes transmitting a light image from a lighting system located on the first aircraft, receiving the light image from the first aircraft using an imaging system located on a second aircraft, determining the spatial positioning between the lighting system and the second aircraft using a processor in communication with the imaging system, and communicating flight instructions to the second aircraft in order to achieve the desired in-flight spatial positioning autonomously.

Embodiments of the present invention provide increased dynamic positional accuracy over present efforts in autonomous refueling methods by using inexpensive commercially available hardware and minimal tanker integration cost and risk. The centroiding method used is computationally more efficient (requires fewer processing resources and is faster) than the image correlation processing necessary in existing systems, and fully meets the stated positional accuracy requirements. The use of a specific wavelength range and appropriate filters further simplify the image, making the resulting centroiding calculations more efficient. In addition, the use of near-infrared lighting elements and camera filtration limits the possibility of visual detection and tracking of the aircrafts by threats during operation. Moreover, the present invention allows for use without the aid of a GPS satellite.

### BRIEF DESCRIPTION OF THE DRAWINGS

So that the manner in which the above-recited features, advantages, and objectives of the invention, as well as others that will become apparent, are attained and can be understood in detail, more particular description of the invention briefly summarized above may be had by reference to the embodiments thereof that are illustrated in the drawings that form a part of this specification. It is to be noted, however, that the appended drawings illustrate only several embodiments of the invention and are, therefore, not to be considered limiting of the invention's scope, for the invention may admit to other equally effective embodiments.

FIG. 1 is a side bottom view of a midair refueling using a boom and receptacle type refueling system in accordance with an embodiment of the present invention.

FIG. 2 is a rear bottom view of a tanker aircraft having a boom type refueling system in accordance with an embodiment of the present invention.

FIG. 3 is a side bottom view of a midair refueling using a hose and drogue type refueling system in accordance with an embodiment of the present invention.

FIG. 4 is head-on view of a drogue equipped according to an embodiment of the present invention.

FIGS. 5A-F are visual depiction of the processor's “view” during the midair refueling.

### DETAILED DESCRIPTION

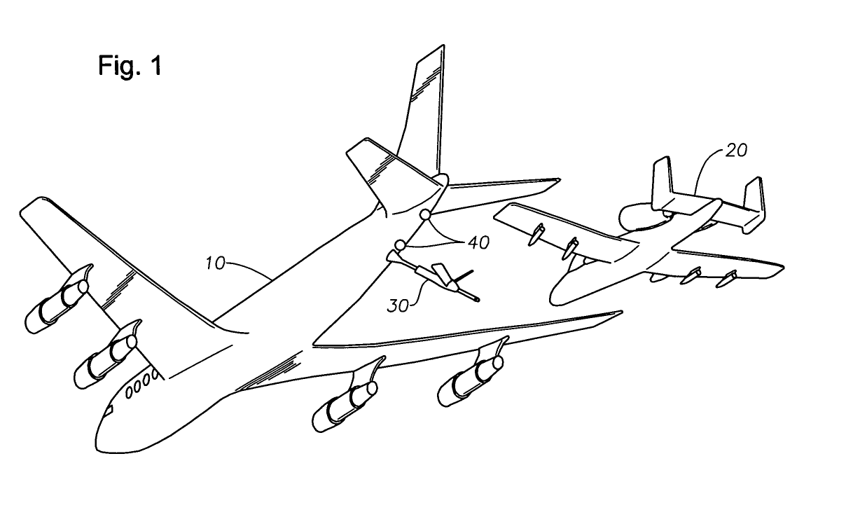

In FIG. 1, a tanker aircraft [10] and a receiver aircraft [20] are in the process of engaging in an air-to-air refueling. In the embodiment shown in FIG. 1, the tanker aircraft [10] is equipped with a boom [30] while the receiver aircraft [20] is equipped with a receptacle (not shown). Furthermore, FIG. 1 shows an embodiment in which vertical light pattern [40] is positioned in a substantially vertical orientation. For purposes of this invention, substantially vertical orientation means that vertical light pattern [40] is along an axis that appears to be in a vertical orientation as viewed from the mating aircraft. In this embodiment, receiver aircraft [20] would be equipped with the camera lens (not shown) on the front portion of receiver aircraft [20].

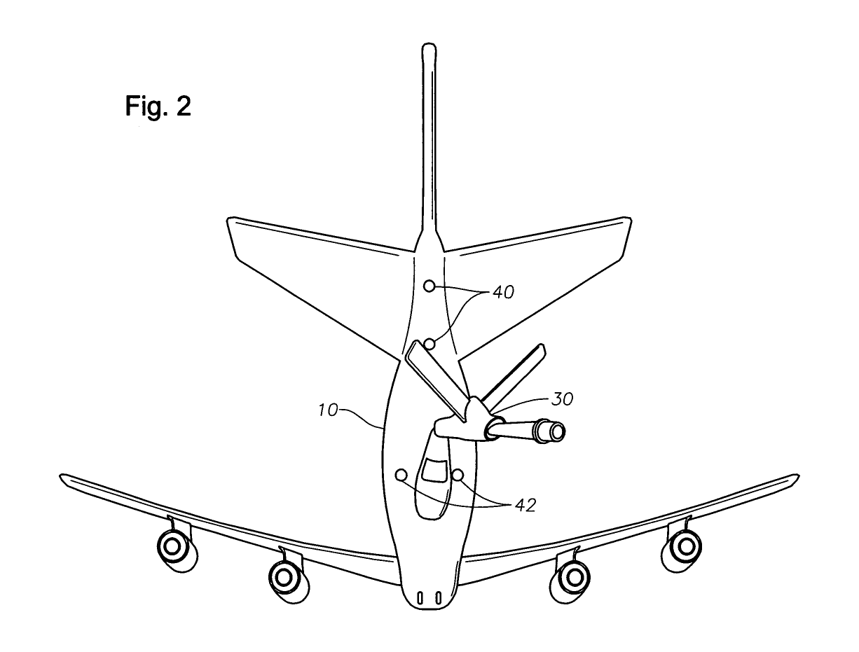

FIG. 2 shows an alternate embodiment in which vertical light pattern [40], which is in a vertical orientation as it was in FIG. 1, is combined with horizontal light pattern [42] that is positioned in a substantially horizontal orientation. For purposes of this invention, substantially horizontal orientation means that horizontal light pattern [42] is along an axis that appears to be in a horizontal orientation as viewed from the mating aircraft. The primary importance is for boom [30] not to block out the line of sight of the camera lens (not shown) on the receiver aircraft (not shown).

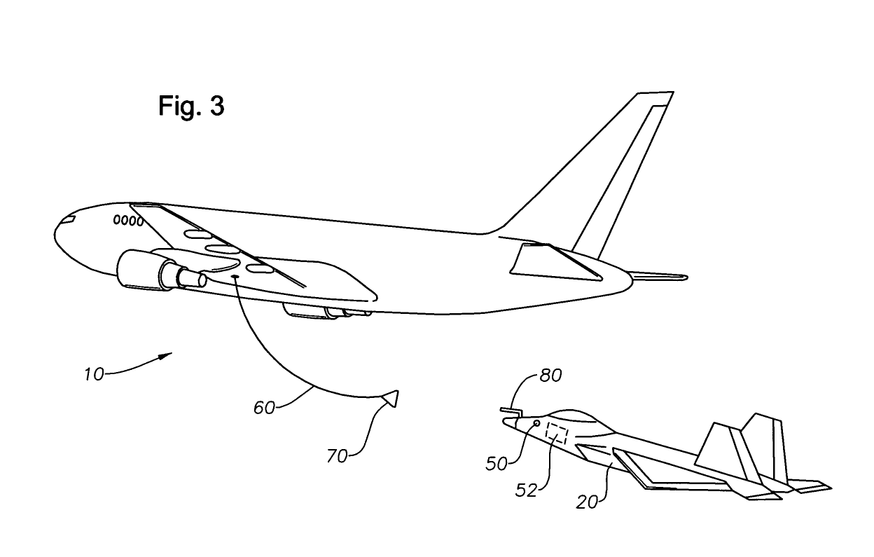

In FIG. 3, a tanker aircraft [10] and a receiver aircraft [20] are in the process of engaging in an air-to-air refueling. In the embodiment shown in FIG. 3, tanker aircraft [10] is equipped with a hose [60] and drogue [70] while receiver aircraft [20] is equipped with a probe [80]. In this embodiment, the lighting elements (not shown) are located on drogue [70] such that camera lens [50] has an open line of sight with the lighting elements during mating. In an additional embodiment, receiver aircraft [20] has a processor [52] electrically coupled to camera lens [50]. Camera tens [50] images a distinct 2D pattern of the lighting elements on drogue [70]. In one embodiment of the present invention, the lighting elements emit a distinctive wavelength that camera lens [50] has been configured to view. These resulting images are processed with a simple centroiding algorithm and used to determine receiver aircraft's [20] six (6) degree of freedom (6 DOF) positional relationship to drogue [70] in preparation for midair refueling. The resulting positional relationship is used to autonomously fly receiver aircraft: [20] to the required positional window for refueling.

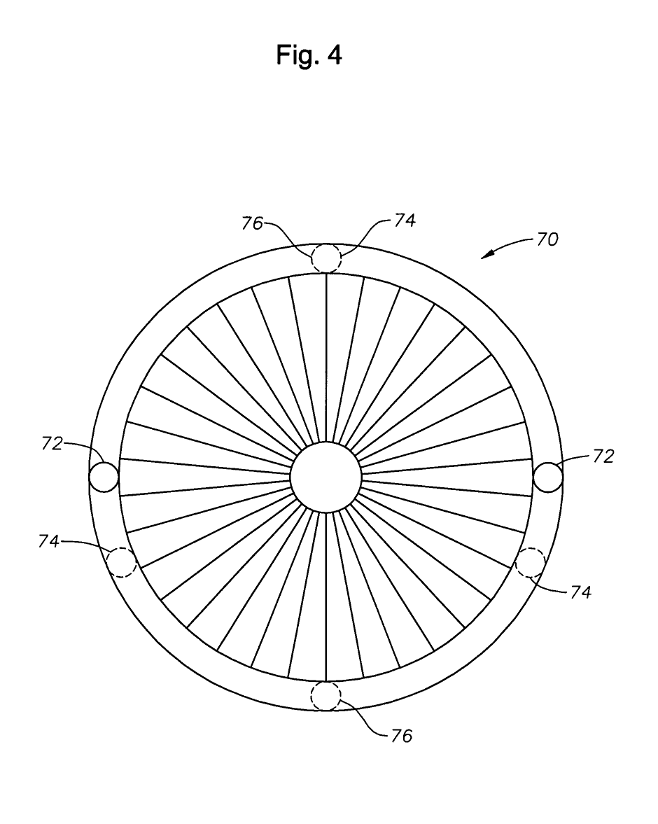

FIG. 4 is a front view of drogue assembly [70] in accordance with multiple embodiments of the present invention. In one embodiment, lighting elements [72] are configured in a horizontal orientation, while in another embodiment, lighting elements [76] are configured in a vertical orientation. Additionally, a further embodiment employs the use of three lighting elements [74] configured in a triangular orientation. A person of ordinary skill in the art will readily appreciate the many variances which can be made in accordance within the scope of the present invention.

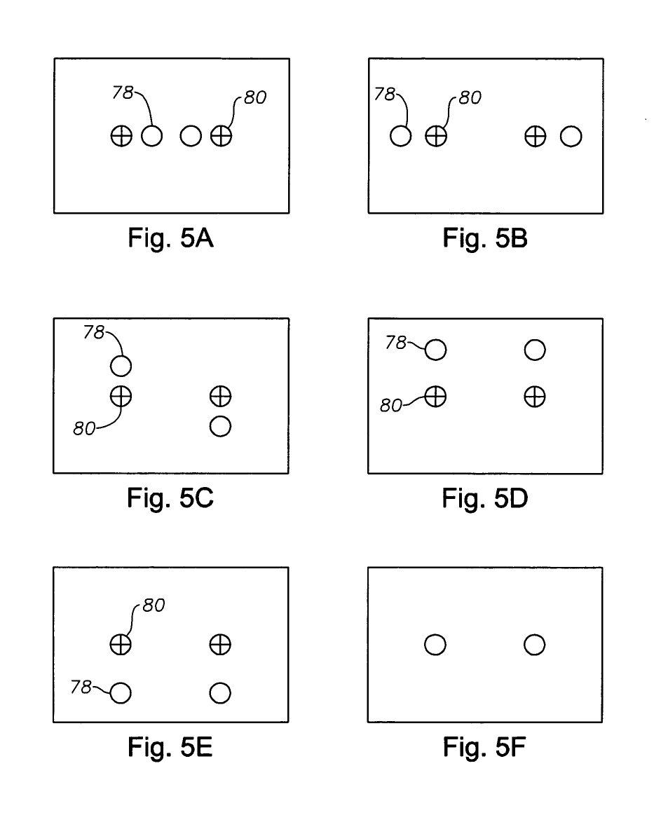

FIGS. 5A-F are visual demonstrations of what the processor would “see” during an attempted mating. In all embodiments shown in FIG. 5, the lighting elements were configured in a horizontal orientation, where circles [78] represent what the processor is seeing and the circles with lines [80] represent the processor's target. FIG. 5A illustrates a situation in which the spatial positioning is too far away. FIG. 5B illustrates the opposite. In this situation, the spatial positioning is too close. In FIG. 5C, the spatial distance is correct; however, the receiver aircraft needs to roll to the right (clockwise). FIG. 5D has the correct spatial distance; however, the receiver aircraft is too low. In FIG. 5E, the spatial distance is correct, but this time the receiver aircraft is too high. Finally, FIG. 5F illustrates what the processor would “see” when the spatial positioning is correct.

As will be readily apparent to those skilled in the art, the present invention may easily be produced in other specific forms without departing from its spirit or essential characteristics. For instance, while the figures and described embodiments discuss having the light pattern on the tanker aircraft and the imaging system on the receiver aircraft, one of ordinary skill will readily recognize that they can be switched. Additionally, many of the embodiments are discussed in relation to UAVs; however, the present invention can be also be used for a manned aircraft that is operating on auto-pilot, as well as a variety of unmanned vehicles on the ground or at sea. The presented embodiments are, therefore, to be considered as merely illustrative and not restrictive, the scope of the invention being indicated by the claims rather than the foregoing description, and ail changes which come within the meaning and range of equivalence of the claims are therefore intended to be embraced therein.

We claim:

1. An automatic positioning system to facilitate dynamic spatial positioning of a first object with a second object, the positioning system comprising:
a first object;
a second object;
a light pattern located on the first object, wherein the light pattern comprises a distinct geometric pattern of lighting elements;
an imaging system located on the second object, wherein the imaging system is operable to receive a light signal from the lighting elements while having a clear line of sight with the light elements; and
a processor in communication with the imaging system, wherein the processor is operable to determine the spatial positioning between the first object and the second object, the processor further operable to communicate instructions to the second object, such that the second object can achieve the desired spatial positioning autonomously.

2. The positioning system of claim 1, wherein the first object and the second object are both aircrafts.

3. The positioning system of claim 2, wherein one of said aircraft's is a tanker aircraft and the other said aircraft is a receiver aircraft.

4. The positioning system of claim 3, wherein the tanker aircraft further comprises a hose and drogue and the receiver aircraft further comprises a probe, wherein the light pattern is positioned on the drogue and the imaging system is positioned on a forward, upper surface of the receiver aircraft.

5. The positioning system of claim 3, wherein the tanker aircraft further comprises a boom and the receiver aircraft further comprises a receptacle, wherein the light pattern is positioned on an aft portion of the tanker aircraft and the imaging system is positioned on a forward, upper surface of the receiver aircraft.

6. The positioning system of claim 2, wherein the lighting elements are selected from the group consisting of light emitting diodes, glassbead reflectors, fiber optics, and combinations thereof.

7. The positioning system of claim 2, wherein the lighting elements are operable to emit light in a specified wavelength range, wherein the lighting elements are selected from the group consisting of light emitting diodes, fiber optics, and combinations thereof.

8. The positioning system of claim 7, wherein the imaging system further comprises a high-resolution camera lens operable to only receive light signals within the specified wavelength range of the lighting elements.

9. The positioning system of claim 8, wherein the specified wavelength range is 0.75 to 1.4 μm.

10. The positioning system of claim 8, wherein the specified wavelength range is 0.8 to 0.9 μm.

11. The positioning system of claim 2, wherein the light pattern further comprises lenses, the lenses operable to limit the solid angle of radiation from the lighting elements.

12. The positioning system of claim 2, wherein the processor determines the spatial positioning of said aircrafts using a centroiding algorithm.

13. An automatic aircraft positioning system to facilitate in-flight re-fueling of a receiver aircraft by a tanker aircraft, the positioning system comprising:
a receiver aircraft;
a tanker aircraft;
a plurality of lighting elements located on the tanker aircraft, the lighting elements operable to transmit light within a specified wavelength range, the lighting elements being spaced relative to each other in a selected geometric pattern;
an imaging system located on the receiver aircraft, wherein the imaging system has a camera lens operable to receive light only within the specified wavelength range from the plurality of lighting elements while having a clear line of sight with the plurality of lighting elements;
a processor in communication with the imaging system, wherein the processor is operable to determine the spatial positioning between the plurality of lighting elements and the receiver aircraft by comparing an observed pattern to the selected geometric pattern as to whether the observed pattern and the selected geometric pattern align, the processor further operable to communicate instructions to the receiver aircraft, such that the receiver aircraft can achieve the desired in-flight spatial positioning autonomously.

14. The automatic aircraft positioning system of claim 13, wherein the plurality of lighting elements farther comprise lenses, the lenses operable to limit the solid angle of radiation from the plurality of lighting elements.

15. The automatic aircraft positioning system of claim 13, wherein the tanker aircraft further comprises a hose and drogue and the receiver aircraft further comprises a probe.

16. The automatic aircraft positioning system of claim 13, wherein the tanker aircraft further comprises a boom and the receiver aircraft further comprises a receptacle.

17. A method to facilitate dynamic in-flight spatial positioning of a first aircraft with a second aircraft the method comprising:
transmitting a light image from a lighting system located on the first aircraft;
receiving the light image from the first aircraft using an imaging system on a second aircraft, wherein there is a clear line of sight between the imaging system and the lighting system;
determining the spatial positioning between the lighting system and the second aircraft using a processor in communication with the imaging system; and
communicating instructions to the second aircraft, such that the second aircraft can achieve the desired in-flight spatial positioning autonomously.

18. The method of claim 17, wherein the step of transmitting a light image is conducted using a light source, wherein the light source is selected from the group consisting of light emitting diodes, fiber optics, and combinations thereof, wherein the light source is configured to emit light only within a specified wavelength range, and wherein the imaging system comprises a camera lens operable to filter out all wavelengths of light not within the specified wavelength range.

19. The method, of claim 17, further comprising limiting the solid angle of radiation from the light source.

20. The method of claim 17, wherein the processor determines the spatial positioning between the first aircraft and the second aircraft using a centroiding algorithm.
